(19) United States
(12) Patent Application Publication
(10) Pub. No.: US 2010/0214868 A1
(43) Pub. Date: Aug. 26, 2010

(54) Agitator and Agitation Method

(75) Inventors: Katsuhide Takenaka, Ehime (JP); Philippe Andre Tanguy, Montreal (CA); Mourad Heniche, Montreal (CA); Arash Iranshahi, Montreal (CA)

Correspondence Address: THE WEBB LAW FIRM, P.C., 700 KOPPERS BUILDING, 436 SEVENTH AVENUE, PITTSBURGH, PA, 15219, US

(73) Assignee: SHI MECHANICAL & EQUIPMENT INC., Saijo-shi, Ehime (JP)

(21) Appl. No.: 12/438,068

(22) PCT Filed: Oct. 4, 2006
(86) PCT No.: PCT/JP2006/319878

§ 371 Date: Feb. 19, 2009

(51) Int. Cl. B01F 7/18

(52) U.S. Cl. 366/316; 366/315

(57) ABSTRACT

It is an object of the present invention to provide an agitator equipped with a bottom paddle that has favorable agitation performance also in a streamline flow region of low Re number and to provide an agitation method. According to the agitator and the agitation method of the present invention, an object is agitated within an agitation tank by the use of an agitator that includes a rotating shaft that is disposed outside of the tank along the axis of a vertically oriented cylindrical agitation tank to be rotatable, and a flat agitation impeller made up of a bottom paddle, which lower end edge is formed to be of a shape that conforms with a tank bottom wall such that a specified clearance is formed between the lower end edge and the tank bottom wall, the bottom paddle being provided with a communicating portions at a positions away from the lower end edge upward by a specified amount for communicating between the front side and the rear side of the bottom paddle, and being mounted to the rotating shaft so as to locate close to the tank bottom wall and extend towards a sidewall of the tank.

### TECHNICAL FIELD

The present invention relates to an agitator for performing agitation processes aiming to achieve mixing, dissolution, crystallization, reaction or the like and to an agitation method.

### BACKGROUND ART

Agitation processes of objects to be agitated in streamline flow region and transitional flow regions (in which the Reynolds (Re) number is in the range of approximately several tens to thousand) were conventionally performed using agitators comprised with multi-staged small-sized impeller such as a paddle impeller, a turbine impeller or a propeller impeller.

In case of such agitation blades that are vertically discontinuous (multi-staged), an object to be agitated is pumped in a radial direction of an agitation tank (hereinafter also simply referred to as “tank”) 21 from respective agitation blades 20, 20, . . . as shown in FIG. 8. The pumped object is vertically separated upon hitting a sidewall 22 of the tank 21. The vertically separated object either moves upward or downward along the sidewall 22 of the tank 21. The object which has moved upward or downward is pumped from between respectively vertically adjoining agitation blades 20, 20, . . . and interferes (hits) an object to be agitated that similarly moves upward or downward along the sidewall 22 of the tank 21. The interfered object moves towards the center of the tank 22 (direction of an agitation shaft 23) and repeatedly returns to the respective agitation blades 20, 20, . . . from which it has been pumped. In other words, the object is agitated while forming a plurality of vertically separated circulating flows.

In this manner, an object to be agitated that is agitated by the agitation blades 20, 20, . . . that are vertically discontinuous does not create a single circulating flow within the agitation tank 21 in which the single circulating flow circulates vertically throughout the entire agitation tank from a tank bottom portion to a fluid surface. Further, a plurality of partition zones Z, Z, . . . are formed between upper and lower objects to be agitated, and formation of a doughnut ring-shaped stagnation region becomes significant around the center of circulation flow within each partition zone. As a result, partition walls between the plurality of partition zones prevent mutual liquid exchange therebetween, and the agitation performance is not favorable due to the presence of the stagnation portions. Moreover, since the plurality of blades 20, 20, . . . are formed, the shape of the blades tends to become complicated. The agitation blades 20, 20, . . . will accordingly be of high manufacturing costs and will also be hard to clean.

Accordingly, an agitator 30 equipped with an agitation impeller 31 as shown in FIG. 9 was proposed. The agitation impeller 31 is made up of a bottom paddle (agitation blade) 31 that is formed in a plate shape that is wide-ranged in a vertical direction with a lower end edge thereof being arranged in proximity to a tank bottom wall 32.

When an object M undergoes agitation processes in the agitator 30 equipped with the bottom paddle 31, the object M that is present on the tank bottom portion is first pumped in a radial direction of an agitation tank 33 upon rotation of the bottom paddle 31. The pumped object M hits a sidewall 34 of the tank. The object M that has hit moves upward along the sidewall 34 of the tank 33. The object M which has moved upward moves (flows) in a direction of a rotating shaft 35 (tank center portion), in proximity to the fluid surface. The object M that has moved to the proximity of the rotating shaft 35 moves downward to the tank bottom portion along the rotating shaft 35. The object M that has moved downward to the tank bottom portion again returns to the bottom paddle 31 from which it has been pumped. The object M that has returned to the bottom paddle is then again pumped in a radial direction of the agitation tank 33.

In this manner, the object M forms a single vertically circulating flow that entirely circulates throughout the region from the tank bottom portion to the fluid surface. In other words, the object M circulates through the entire tank without forming any partition zones and is thus agitated. As a result, the agitation performance becomes better (or is improved).

### DISCLOSURE OF THE INVENTION

### Problem to be Solved by the Invention

However, the agitator 30 equipped with the above bottom paddle 31 does not exhibit favorable agitation performances for an object having high viscosity, or in a streamline flow region of low (not more than several tens of) Re number.

The reason for this is that in a streamline flow region of low (not more than several tens of) Re number, if an object m within the agitation tank 33 is of high viscosity, the object m will form a large vertically circulating flow that circulates through substantially the entire tank 33 and a small circulating flow that circulates only at the tank bottom portion and is thus separated into two regions. These two regions do not exchange the objects m, which circulate within respective regions, with each other. Therefore, the object m that flows within the small circulating flow continues circulating in the small region of the tank bottom portion and stays at the tank bottom portion.

In other words, after being pumped from the bottom paddle 31 in the radial direction of the agitation tank 33, the object m hits the sidewall 34 of the tank. At this time, the object m that has hit the sidewall 34 of the tank does not entirely move upward along the sidewall 34 of the tank. Apart of the object m that has hit the sidewall 34 of the tank moves downward towards the bottom portion of the tank along the sidewall 34 of the tank. The object m that has moved downward moves towards the center portion of the tank (rotating shaft 35) from the sidewall 34 of the tank 33 along the bottom wall 32. The object m that has moved towards the center portion of the tank 33 moves upward along the rotating shaft 35. The object m then returns to the bottom paddle 31 and is again pumped in the radial direction of the tank 33. Thus, the small circulating flow is formed.

When agitating an object that is of low viscosity, the small circulating flow is immediately collapsed through positive pressure that is generated on the front side of the rotating bottom paddle (on the upstream side in the rotating direction). Accordingly, the small circulating flow immediately vanishes so that only the single vertically circulating flow remains.

However, when agitating an object of high viscosity, the small circulating flow continues circulation without collapsing while rotating (co-rotating) with the bottom paddle around the rotating shaft within the tank.

More specifically, when agitating the object using a bottom paddle, positive pressure is generated on the front side of the rotating bottom paddle (on the upstream side in the rotating direction) since the object that is located on the front side of the bottom paddle is pushed away towards the front side of the bottom paddle. On the other hand, on the rear side of the bottom paddle (on the downstream side in the rotating direction), negative pressure is generated since the object is flowing around from the periphery of the rear side of the bottom paddle by the movement of the bottom paddle in the rotating direction. When an object of high viscosity (of low Re number) is agitated, the above actions will remarkably appear so that the positive pressure and the negative pressure that are respectively generated on the front side and the rear side, of the bottom paddle will become large.

Accordingly, when an object of high viscosity is agitated using the bottom paddle, the small circulating flow is drawn by the negative pressure, which is generated on the rear side of the rotating bottom paddle, and thus co-rotate with the bottom paddle. The small circulating flow that co-rotates with the bottom paddle is not collapsed by the positive pressure that is generated on the front side of the rotating bottom paddle but continues circulating. As a result, the object that makes up the small circulating flow is not mixed with an object of the other region.

An agitator equipped with a bottom paddle is thus disadvantaged in that its agitation performance in the streamline flow region is poor.

It is an object of the present invention to provide an agitator equipped with a bottom paddle that has favorable agitation performance also in a streamline flow region of low Re number and to provide an agitation method.

### Means for Solving the Problem

For achieving the above object, according to the present invention, there is provided an agitator that includes: a vertically oriented cylindrical agitation tank, a rotating shaft that is disposed outside of the tank along the axis of the agitation tank to be rotatable, and an agitation impeller made of a plate-shaped bottom paddle that is mounted to the rotating shaft so as to locate close to a tank bottom wall and extend towards a sidewall of the tank, wherein the bottom paddle is formed to be of a shape that conforms with the tank bottom wall such that its lower end edge is spaced apart from the tank bottom wall by a specified clearance, and wherein communicating portions that communicate between the front side and the rear side of the bottom paddle are formed at positions away from the lower end edge upward by a specified amount.

According to the above arrangement, the bottom paddle is provided with communicating portions that communicate between the front side and the rear side of the bottom paddle at positions displaced from the lower end edge upward by a specified distance. The bottom paddle rotates within the tank around the rotating shaft when agitating the object within the tank. When the bottom paddle rotates, the object that is located on the front side of the bottom paddle moves to the rear side through the communicating portions.

When the bottom paddle rotates within the tank filled with an object, positive pressure is generated on the front side of the bottom paddle since the front surface of the bottom paddle is pushing away the object that is located on the front side of the bottom paddle. Further, since the bottom paddle performs rotational movements, negative pressure is generated on the paddle rear side since the object is flowing around towards the rear side of the bottom paddle. Particularly, when an object of low Re number, that is, of high viscosity is to be agitated, the positive pressure and the negative pressure generated on the front side and the rear side, of the bottom paddle become large.

Further, upon the rotation of the bottom paddle, the object that is located on the front side of the bottom paddle is pushed away to the front surface of the bottom paddle while it is also pumped towards the sidewall of the tank through centrifugal force. This pumped object hits the sidewall of the tank. The object that has hit moves (flows) along the sidewall of the tank upon separating in vertical directions. The object that moves upon separating in vertical directions moves towards the rotating shaft along the fluid surface or the bottom wall of the tank. The object that has moved to the proximity of the rotating shaft returns to the bottom paddle along the rotating shaft. The object that has returned to the bottom paddle is again pumped in the radial direction.

In other words, within the tank, there are formed a large vertically circulating flow that is formed in a region from the center of the bottom paddle disposed to be close to the tank bottom wall to the fluid surface and a small circulating flow that is formed in a region from the center portion of the bottom paddle to the bottom wall of the tank.

In case no communicating portions are provided at the bottom paddle, the small circulating flow of the two circulating flows is drawn by the negative pressure that is generated on the rear side of the rotating bottom paddle and co-rotates with the bottom paddle. Since the small circulating flow co-rotates with the bottom paddle, it continues its circulation without being collapsed by the rotating bottom paddle. As a result, the small circulating flow, and particularly the object at the center portion thereof is unlikely to be mixed (agitated) with the object that is located outside the small circulating flow.

However, the paddle of the above structure is arranged so that the object passes through the communicating portions from the front side to the rear side of the paddle as described above. Accordingly, the negative pressure generated on the rear side of the bottom paddle becomes small. The small circulating flow accordingly is not drawn by the negative pressure on the rear side of the bottom paddle and thus does not co-rotate therewith. As a result, the small circulating flow is pushed away by the front surface of the rotating bottom paddle, and a part thereof passes through the communicating portions to the rear side of the bottom paddle and then is collapsed (agitated).

In the present invention, by the front surface of the bottom paddle is meant herein a surface on the upstream side in the rotation direction within the tank. Also, by the rear surface of the bottom paddle is meant herein a surface on the downstream side in the rotating direction within the tank.

The communicating portions may also be formed along the radial direction of the agitation tank.

According to the above arrangement, the communicating portions are formed along the radial direction at a lower portion of the bottom paddle that is disposed to be close to the bottom wall of the tank. It will accordingly be easier for the bottom paddle to make the small circulating flow collapse. The agitation performance thus becomes favorable also in a streamline flow region of low Re number.

More particularly, since the small circulating flow is formed to extend from the center portion of the bottom paddle to the bottom wall of the tank, it is flat in the radial direction of the tank. The communicating portions of the bottom paddle are formed at positions at which they move across the flat small circulating flow. Accordingly, when the bottom paddle rotates such that it passes a position (portion) at which the small circulating flow is formed, portions of the small circulating flow corresponding to the communicating portions pass through the communicating portions to the rear side of the bottom paddle, and the residual portions thereof are pushed away by the front surface of the bottom paddle to move in the radial direction (to be pumped).

In this manner, the bottom paddle divides the small circulating flow through the communicating portions across the major axis (longer axis of the flat circulating flow) and at the same time pushes (pumps) the divided portions through the front surface in the radial direction so as to make the small circulating flow collapse. As a result of the collapse of the small circulating flow, the object within the tank can be agitated more easily with other portions (vertically circulating flow), and the agitation performance is accordingly increased.

The communicating portions may be made up of at least one of holes and openings.

According to the above arrangement, when the bottom paddle rotates and passes a position (portion) at which the small circulating flow is formed, portions of the small circulating flow corresponding to the communicating portions pass through communicating portions that are formed as at least either one of a plurality of holes and openings in the paddle to the rear side of the bottom paddle.

Accordingly, the object of the small circulating flow moves to the rear side of the paddle through plural portions. The small circulating flow is consequently more finely divided so that it collapses easily such that the agitation performance is improved.

According to the present invention, by the holes formed in the bottom paddle are meant holes, each having a closed annular peripheral edge so as to be isolated from the outside. Also, by the openings are meant openings each having a partially opened annular peripheral edge so as to be communicated with the outside.

Further, the connecting portions may be formed in the bottom paddle respectively on the right and left sides thereof with the rotating shaft therebetween.

According to the above arrangement, the paddle hits the small circulating flow simultaneously with its right and left sides with the rotating shaft therebetween. The paddle can accordingly make the small circulating flow collapse simultaneously with its right and left sides around the rotating shaft. The agitation performance can accordingly be further improved. In this respect, the communicating portions may be formed to be symmetric on the right and left side around the rotating shaft. With such an arrangement, the manufacturing cost of the agitation impeller can be reduced.

The agitation impeller may include a lattice blade located above the bottom paddle.

According to the above arrangement, the vertically circulating flow that is formed in a region from the center portion of the bottom paddle to the fluid surface is agitated by the lattice blade. The agitation performance within the tank can be further improved thereby.

The lattice blade may be arranged to have a width gradually narrows towards the above.

According to the above arrangement, the lattice blade increases in radial width as it advances downward so that the distance between the edge of the blade and the rotating shaft becomes larger the more closer to the bottom. Thus, the pumping power of the object becomes large. Accordingly, the pumping flow of the object in the radial direction that is pumped by the lattice blade becomes larger the closer to the bottom. It is accordingly be easier to form an upward flow of the object along the wall surface. The circulating flow in the vertical direction is consequently formed more easily so that the agitation performance is further improved.

According to another aspect of the present invention, there is provided an agitation method including agitating an object within an agitation tank by the use of an agitator that includes a rotating shaft that is disposed outside of the tank along the axis of a vertically oriented cylindrical agitation tank to be rotatable, and a flat agitation impeller made up of a bottom paddle, which lower end edge is formed to be of a shape that conforms with a tank bottom wall such that a specified clearance is formed between the lower end edge and the tank bottom wall, the bottom paddle being provided with communicating portions at positions away from the lower end edge upward by a specified amount for communicating between the front side and the rear side of the bottom paddle, and being mounted to the rotating shaft so as to locate close to the tank bottom wall, and extend towards a sidewall of the tank.

According to the above method, the object is agitated by means of a paddle that is provided with communicating portions at positions displaced upward from the lower end edge by a specified amount. With this arrangement, the small circulating flow is thus divided by the paddle as described above and collapsed. The agitation performance of agitation using the agitator equipped with the paddle is consequently improved.

The object may be agitated in a streamline flow region.

When the object is agitated in a streamline flow region by means of the bottom paddle, the small circulating flow easily co-rotates with the paddle. Accordingly, further improvements in agitation performance will be realized with the above method when compared to a case in which agitation is performed in the transition flow region.

### ADVANTAGES OF THE INVENTION

As described above, the present invention provides an agitator equipped with a bottom paddle blade that exhibits favorable agitation performance also in a streamline flow region of low Re number, as well as an agitation method.

### BRIEF DESCRIPTION OF THE DRAWINGS

FIG. 1 is a schematic front view of an agitator according to an embodiment.

FIG. 2 is a front view showing a flow of the object in the agitator of the same embodiment in detailed form.

FIG. 3 is a front view showing a flow of the object in the agitator of the same embodiment in schematic form.

FIG. 4 is a front view of an agitation impeller made up of a bottom paddle only in an agitator according to another embodiment.

In FIG. 5 of the agitator according to the other embodiment, FIG. 5 (i) is a front view of an agitation impeller provided with communicating portions on only either of its right or left side and FIG. 5 (ii) is a front view of an agitation impeller provided with communicating portions that are asymmetrically arranged.

In FIG. 6 of the agitator according to the other embodiment, FIG. 6 (iii) to FIG. 6 (viii) are partially enlarged views of agitation blades showing other examples of the communicating portions.

FIG. 7 is a view showing results of simulation of agitating conditions between one example of the agitation impeller of the present embodiment and one using an agitation impeller including no communicating portions.

FIG. 8 is a front view showing a flow of an object to be agitated in schematic form in an agitator equipped with conventional small-sized blades.

FIG. 9 is a front view showing a flow of an object to be agitated in schematic form in an agitator equipped with a conventional bottom paddle.

FIG. 10 is a front view showing a flow of an object to be agitated in schematic form in an agitator equipped with a conventional bottom paddle within a streamline flow region of low (not more than several tens of) Re number.

### EXPLANATION OF THE REFERENCE NUMERALS

1 . . . agitator, 2 . . . agitation tank, 3 . . . rotating shaft, 4 . . . bottom paddle (bottom paddle portion), 5 . . . lattice blade (lattice blade portion), 6 . . . agitation impeller, 7 . . . sidewall, 8 . . . bottom wall, 9 . . . cutaway, 10 cutaway, 11 . . . communicating portion, 12 . . . arm, 13 . . . strip, 20 . . . agitation blade (small-sized blade), 21 . . . agitation tank, 22 . . . sidewall, 23 rotating shaft, 30 agitator, 31 . . . bottom paddle (agitation blade), 32 . . . bottom wall, 33 . . . agitation tank, 34 . . . sidewall, 35 . . . rotating shaft, C vertically circulating flow, c . . . small circulating flow, M . . . object to be agitated of low viscosity (high Re number), m . . . object to be agitated of high viscosity (low Re number), z . . . partitioned zone

### BEST MODE FOR CARRYING OUT THE INVENTION

One embodiment of the present invention will now be explained with reference to the accompanying drawings.

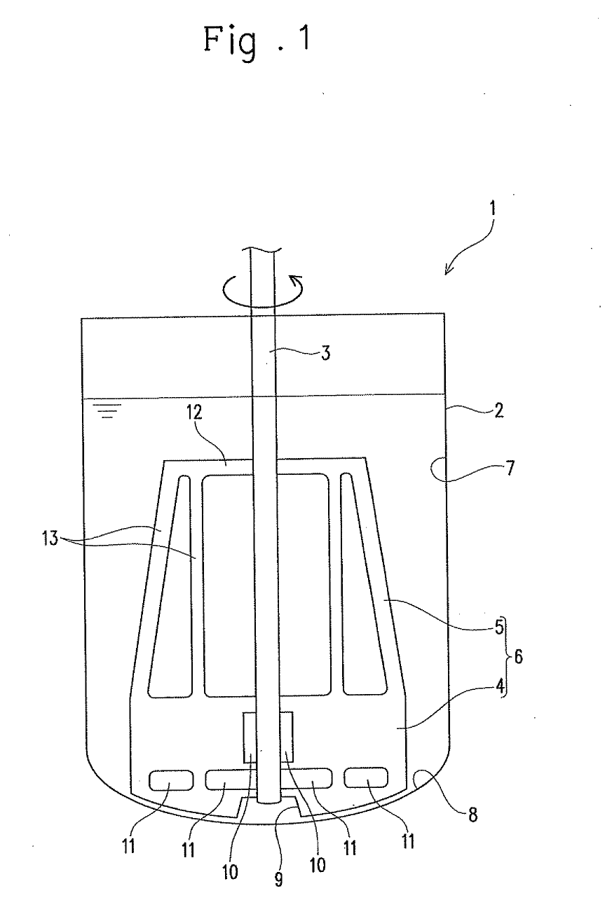

As shown in FIG. 1, an agitator 1 according to the present embodiment includes a cylindrical agitating tank 2, a rotating shaft 3 that is disposed along the axis of the tank 2, a plate-shaped bottom paddle (or bottom paddle portion, hereinafter simply referred to as “paddle”) 4 mounted to the rotating shaft 3, and an agitation impeller 6 made up of a lattice blade (or lattice blade portion) 5 formed by vertical and horizontal strip-shaped plates, which is continuously formed with an upper portion of the paddle 4.

The tank 2 is a vertically oriented cylindrical vessel with a cylindrical sidewall 7. A bottom portion of the tank 2 is formed such that a bottom wall 8 becomes substantially arc-like in section (semi-elliptic).

The rotating shaft 3 is arranged in that its upper end portion projects outside of the tank from a top portion of the tank 2 while its lower end portion vertically extends to the proximity of the bottom wall 8. The projecting upper end portion is connected to an external driving device (not shown) by means of a coupling (not shown). In this respect, the rotating shaft 3 may alternatively be arranged in that a bearing (not shown) is provided at a center portion of the bottom wall 8 of the tank 2 to support the lower end portion. The driving device that drives the rotating shaft 3 may be provided not above the tank 2 but below the tank 2.

The paddle 4 is formed into a substantially rectangular plate shape. The paddle 4 is shaped such that its lower end edge conforms with the bottom wall 8. In other words, the lower end edge is formed to be substantially arc-like. The lower end edge is formed with a trapezoidal cutaway 9 at a center portion thereof. Rectangular cutaways 10, 10 are formed at the center portion of the paddle 4 along the rotating shaft 3 to be symmetric to the right and left. Communicating portions 11 are formed (provided) at a lower portion of the paddle 4.

The plural communicating portion 11 are aligned in the radial direction. In the present embodiment, the communicating portions 11, 11, are formed by radially extending elongated bores. The elongated bores are formed such that vertical widths thereof become uniform. Two communicating portions 11, 11, are provided on each of the right and left sides of the paddle around the rotating shaft 3. The communicating portions 11, 11, are formed to be symmetric to the right and left around the rotating shaft 3. When the paddle 4 (agitating impeller 6) is disposed in the tank 2, the communicating portions 11, 11, are aligned along a line connecting boundary portions between the sidewall 7 and the bottom wall 8.

The lattice blade 5 is continuously formed with the upper portion of the paddle 4 and is formed of an arm 12 and strips 13. The arm 12 is formed of a laterally (radially) extending strip-shaped plate. The strips 13 are formed of vertically extending strip-shaped plates. In the present embodiment, the lattice blade 5 is formed of a single arm 12 and four strips 13, 13, 13, 13. From among the four strips 13, 13, 13, 13, two radially outwardly disposed strips are disposed to come closer to each other towards the above. In other words, these two strips 13, 13 are inclined to come closer to the rotating shaft 3 as they advance upward.

The agitation impeller 6 made up of the paddle 4 and the lattice blade 5 is mounted to the rotating shaft 3 such that the lower end edge of the paddle 4 is located close to the bottom wall 8 of the tank 2 with a certain clearance. More particularly, the agitation impeller 6 is mounted to the rotating shaft 3 with such a clearance as to prevent slide contact between the lower end edge and the bottom wall 8 of the tank 2 when in rotation (agitation).

In the present embodiment, the agitation impeller 6 is arranged in that the paddle 4 and the lattice blade 5 are integrally formed. In other words, the agitation impeller 6 is made up of the paddle portion 4 and the lattice blade portion 5. However, the present invention is not necessarily limited to this. That is, the paddle 4 and the lattice blade 5 may be respectively formed of different members and then be connected to each other. Alternatively, the paddle 4 and the lattice blade 5 may be disposed close to each other. In other words, the paddle 4 and the lattice blade 5 may be arranged separately with a slight clearance therebetween.

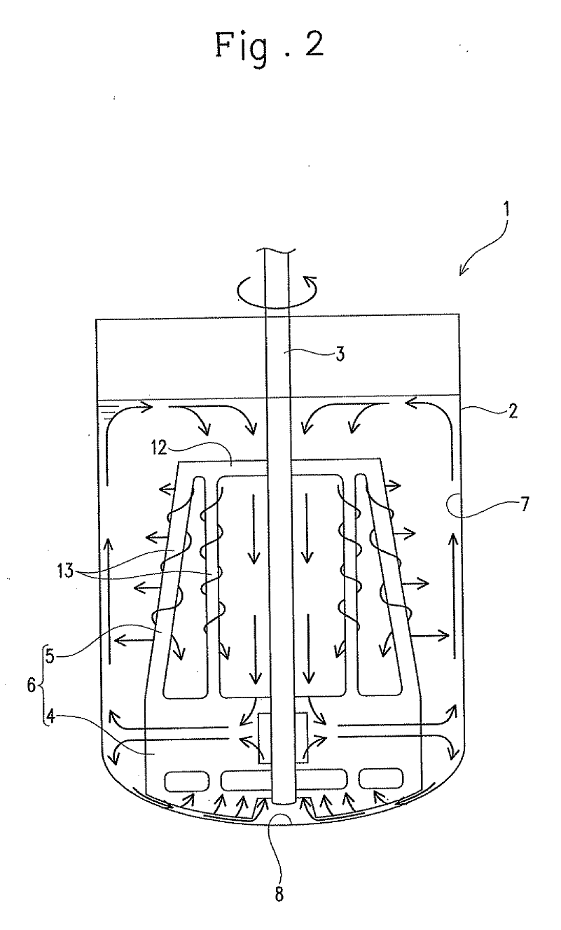

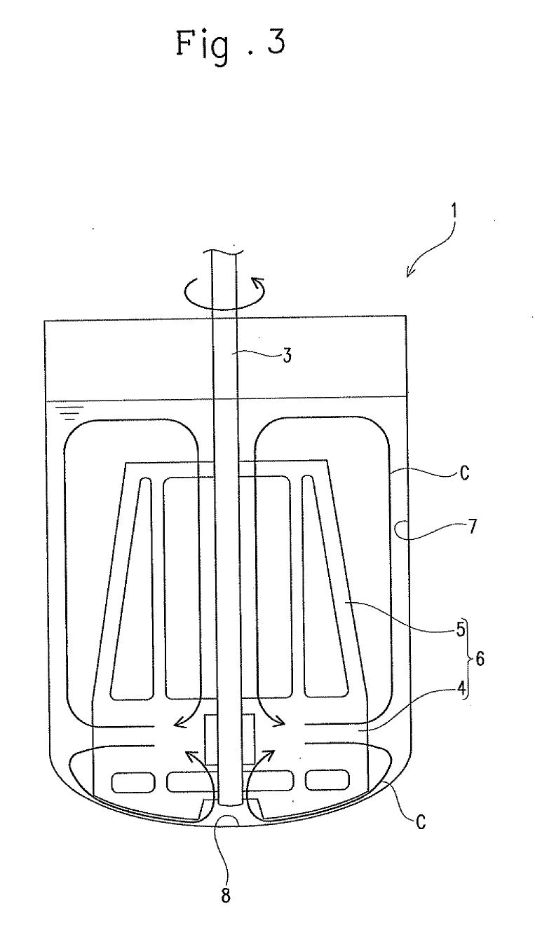

The agitator 1 according to the present embodiment has the above-described structure, and the operation of the agitator according to the present embodiment will now be explained with reference to FIGS. 2 and 3.

An object to be agitated that is placed into the tank 2 is agitated with the rotation of the agitation impeller 6. More particularly, the rotating shaft 3 rotates by means of the driving device. Accompanying this rotation, the agitation impeller 6 rotates within the tank 2. The object is agitated through this rotation of the agitation impeller 6.

More particularly, the object is first pumped radially outwardly from the center portion of the tank 2 (proximity of the rotating shaft 3) by means of the paddle 4. Simultaneously therewith, the object near the bottom wall 8 is scraped off by the lower end edge of the paddle (portion) 4. The paddle 4 can accordingly prevent adhesion of the object to the bottom wall 8. The scraped off object is similarly pumped in the radial direction as discussed above.

The object that has been pumped in the radial direction hits the sidewall 7. The hit object is separated in the vertical direction so as to move upward or downward along the sidewall 7.

The upward object moves upward along the sidewall 7 to the proximity of the fluid surface. At this time, the upward object is pressed towards the sidewall 7 through pumped flow from the strips 13 as will be explained later. It is accordingly even easier for the upward object to move upward along the sidewall 7.

The object that has moved to the proximity of the fluid surface moves towards the center of the tank 2 (rotating shaft 3). Thereafter, the object starts to move downward from the proximity of the rotating shaft 3 and the uppermost arm 12 of the lattice blade 5. The object then returns to the paddle 4. Thus, a large vertically circulating flow C will be formed.

In the vertically circulating flow C, a downward flow of the object is shear-minced by the strips 13, 13. The shear-minced downward flow is caught in a minute swirl generated on the rear side of the arm 12 and the strips 13 and mixed therewith. In this manner, agitation of the object is progressed in the vertically circulating flow C.

Simultaneously therewith, the arm 12 and the strips 13 together pump the object also in the radial direction. The pumped object functions to press the upward flow of the object that moves upward along the sidewall 7 towards the sidewall 7. Moreover, since the distance of the outer strips 13, 13 from the rotating shaft 3 becomes larger the closer to the bottom, the flow velocity of the pumped object becomes larger the closer to the lower portion.

The object that has moved to the lower portion moves from the sidewall 7 towards the center of the tank 2 along the bottom wall 8. At this time, a part of the object that moves along the bottom wall 8 is scraped off by the lower end portion of the paddle 4 and is again pumped in the radial direction. The object that has moved to the center portion of the tank 2 starts moving upward along the rotating shaft 3. The object then returns to the paddle 4. In this manner, the small circulating flow c is formed. This small circulating flow c is a circulating flow that is flat in the radial direction.

Then, when the rotating paddle 4 passes through the portion at which the small circulating flow c is formed, portions of the small circulating flow c corresponding to the communicating portions 11, 11, moves from the front side to the rear side of the paddle 4 through the communicating portions 11, 11. Portions that do not correspond to the communicating portions 11, 11, are pressed to the front surface of the paddle 4 and are further pumped in the radial direction through centrifugal force.

More particularly, of the small circulating flow c, strip-shaped portions that correspond to the communicating portions 11, 11, move from the front side to the rear side of the paddle 4 and are divided across its major axis direction (longer axis of the flat circulating flow).

Since a part of the object of the small circulating flow c moves from the front side to the rear side of the paddle 4 through the communicating portions 11, 11, the negative pressure generated on the rear side of the paddle 4 becomes smaller. The small circulating flow c is accordingly prevented from co-rotating by being drawn by the negative pressure on the rear side of the paddle 4. The small circulating flow c accordingly does not co-rotate with the paddle 4 along the peripheral direction of the tank 2 but hits the front surface of the upcoming paddle 4. The small circulating flow then continuously hits the front surface of the paddle 4 through the rotation of the paddle 4 and then collapses.

At this time, a part of the object that had been forming the collapsed small circulating flow c moves to the upper side of the paddle 4 to merge into the vertically circulating flow C to be agitated. In this manner, the object in the tank 2 is favorably agitated by mutually exchanging portions of the object between the small circulating flow c and the vertically circulating flow C.

As explained so far, according to the agitator 1 of the present embodiment, the small circulating flow c is prevented from co-rotating by providing the communicating portions 11, 11, at positions of the paddle 4 extending along the major axis of the small circulating flow c formed in the tank. The small circulating flow cis gradually collapsed by hitting the front surface of the upcoming rotating paddle 4. Simultaneously therewith, the small circulating flow c will also be collapsed since portions corresponding to the communicating portions 11, 11, move to the rear side of the paddle 4 while the residual portions are pushed out (projected) in the radial direction.

The portions of the object that respectively form the vertically circulating flow C and the small circulating flow c are consequently mutually exchanged and agitated even if agitation is performed in a streamline flow region of low Re number. The agitator 1 is thus capable of swiftly performing favorable agitation in the entire tank.

In this respect, the agitator and the agitation method of the present invention are not limited to those of the above-described embodiment alone, but it is of course possible to add various changes without departing from the scope of the present invention.

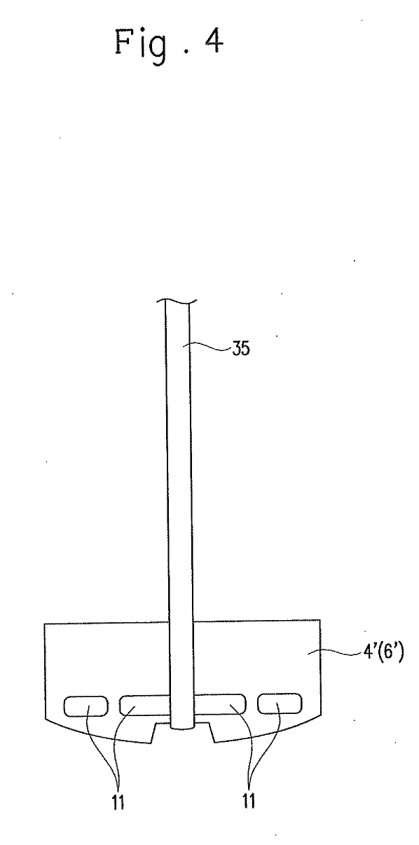

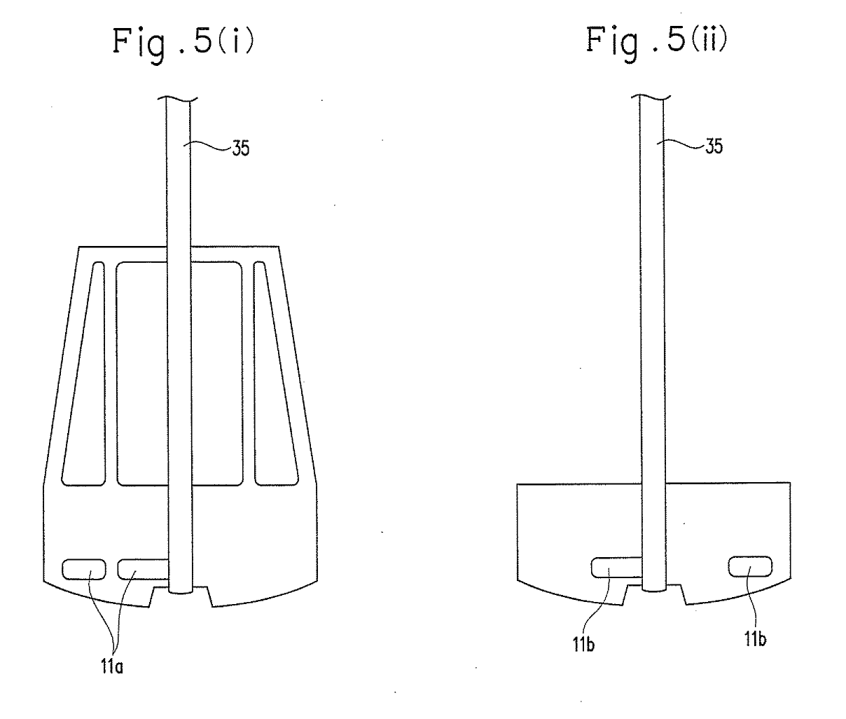

For instance, the agitation impeller of the present embodiment is made up of a bottom paddle portion and a lattice blade portion, but the present invention is not necessarily limited to this. The agitation impeller may be made up the bottom paddle 4′ only as shown in FIG. 4. Even with an agitation impeller 6′ made up of only the bottom paddle 4′, the agitation impeller 6′ having the communicating portions 11 is similarly able to collapse the small circulating flow. Therefore, the agitator that includes the agitation impeller 6′ made up of only the bottom paddle 4′ is able to swiftly agitate an object which is of low Re number. As a result, the agitation performance will be improved also when performing agitation of an object that is of low Re number.

Further, as shown in FIG. 5(i), it is not necessary to provide the communicating portions 11a, which are provided at the bottom paddle (bottom paddle portion), respectively on the right and left sides of the paddle with the agitation shaft 3 therebetween. In other words, the communicating portions 11a may be provided on either the right or left side only. Further, as shown in FIG. 5(ii), it is not necessary to provide the communicating portions 11b to be symmetric on the right and left sides around the agitation shaft 3. In other words, the communicating portions 11b may also be provided to be asymmetric on the right and left sides.

Even with the above arrangements, the communicating portions 11a or 11b serve to move a part of the small circulating flow to the rear side of the bottom paddle when performing agitation so as to make the small circulating flow collapse. Simultaneously therewith, the communicating portions 11a or 11b reduce the negative pressure generated on the rear side of the bottom paddle. Accordingly, an agitator provided with a bottom paddle (bottom paddle portion) having the communicating portions 11a or 11b will exhibit favorable agitation performances in a streamline flow region.

The communicating portions 11 each are not required to be an elongated hole which width is uniform in the vertical direction. The communicating portions 11 are not required to be aligned along the radial direction. It is further not necessary to provide two communicating portions 11 on each of the right and left sides.

For example, as shown in FIG. 6(iii) or FIG. 6(iv), the communicating portions each may also be elliptic such as communicating portion 11c or an asymmetric through-hole such as communicating portion lid. Further, as shown in FIG. 6(v) to (viii), the communicating portions may be arranged in plural rows such as communicating portions lie or not less than three such as communicating portions 11f. The communicating portions may also be openings each having a partially opened peripheral edge, such as communicating portions 11g or 11h.

Even with communicating portions that have shapes such as communicating portions 11c to 11h, it is similarly possible to collapse the small circulating flow and to reduce negative pressure generated on the rear side of the bottom paddle (bottom paddle portion).

### Examples 1

The inventors of the present invention made the simulation for the agitations using an agitator of the present invention with an agitation impeller having the communicating portions (Example 1) and an agitator with an agitation impeller having no communicating portions (Comparative Example 1). The results are shown below.

### <Test Conditions>

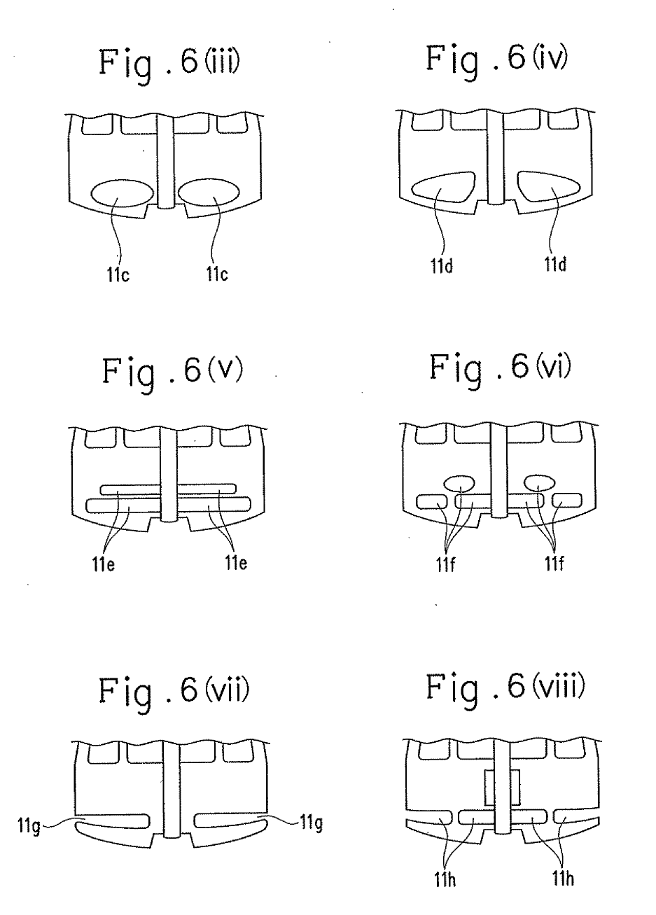

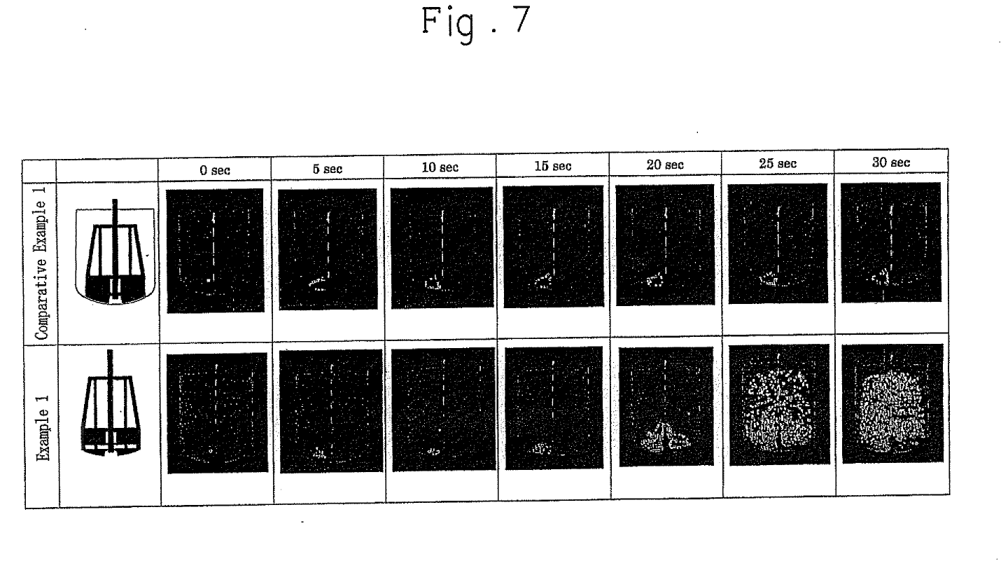

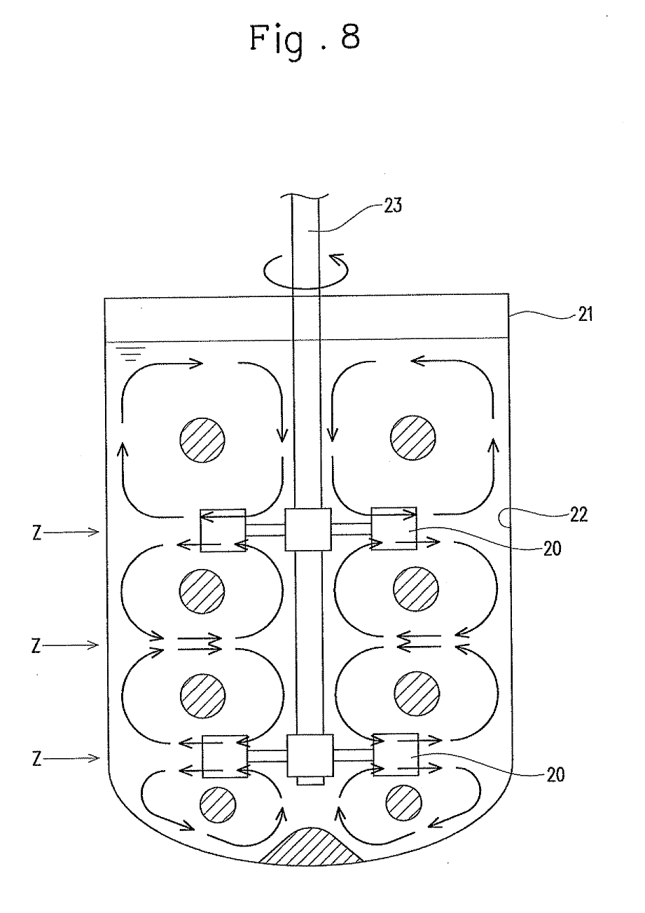

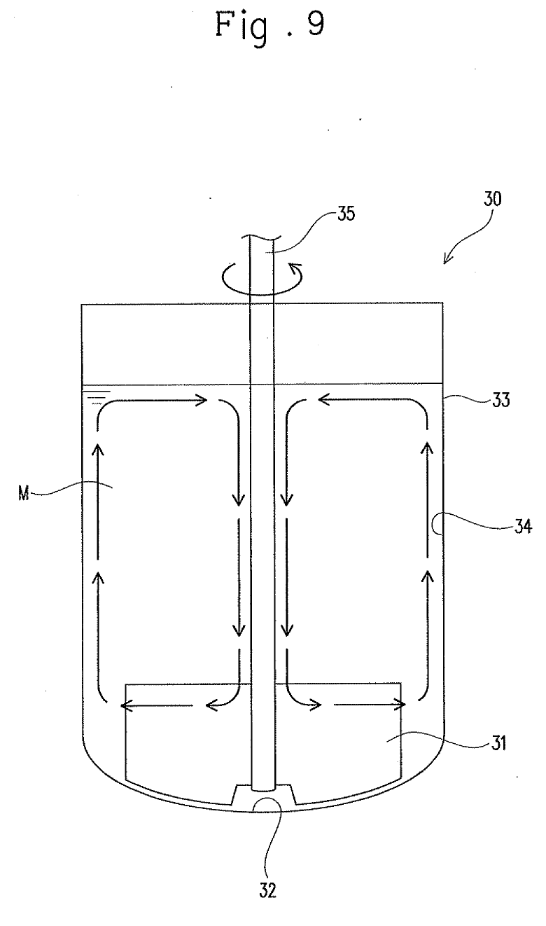

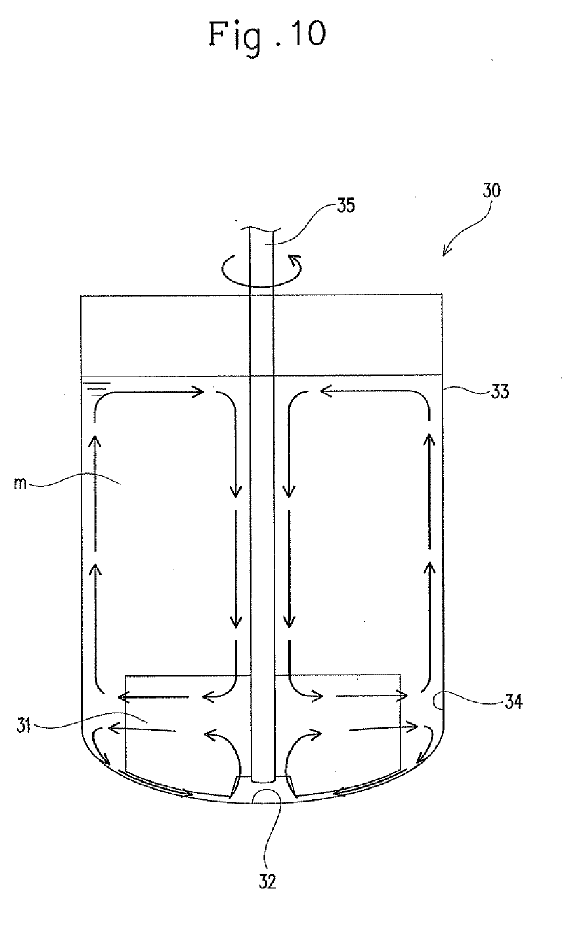

Reynolds number (Re number): 40
Structure of an agitation impeller
   (Example 1): A bottom paddle portion having communicating portions and a lattice blade disposed above (see Example 1 of FIG. 7)
   (Comparative Example 1): A bottom paddle having no communicating portions and a lattice blade disposed above (see Comparative Example 1 of FIG. 7)
Impeller diameter d: 45 cm (maximum width)
Impeller height E: 60 cm (maximum height)
Inner diameter of tank D: 60 cm (inner diameter)
Fluid depth L: 72 cm
Shape of tank bottom portion; substantially arc-like (semi-elliptic)

### <Testing Method>

The present inventors have performed simulations of agitation conditions using POLY3D manufactured by Rheosoft Inc. under the above-mentioned conditions. More particularly, the present inventors have injected 5,000 pieces of tracers of mass 0 into the agitation tank satisfying the above-mentioned conditions onto one side of the agitation impeller, and the results obtained through simulations of positions of the tracers of every 5 seconds when performing agitation are shown in FIG. 7. In this respect, the results of Comparative Example 1 are indicated on the upper row and the results of Example 1 on the lower row.

It will be appreciated from FIG. 7 that the 5,000 pieces of tracers that were injected to the bottom portion dispersed on the bottom portion of the tank after 20 seconds (in the first stage) in Example 1 and that they were agitated throughout the tank after 25 seconds (in the second stage) after moving to the vertically circulating flow. In Comparative Example 1, the tracers would co-rotate with the agitation impeller on the tank bottom portion and the tracers on the tank bottom portion were still not agitated after elapse of 30 seconds from the start of agitation. This result matches with the above facts that can be derived from FIGS. 1 to 3.

1. An agitator comprising:
a vertically oriented cylindrical agitation tank;
a rotating shaft that is disposed outside of the tank along the axis of the agitation tank to be rotatable; and
an agitation impeller made of a plate-shaped bottom paddle that is mounted to the rotating shaft so as to locate close to a tank bottom wall and extend towards a sidewall of the tank,
wherein the bottom paddle is formed to be of a shape that conforms with the tank bottom wall such that its lower end edge is spaced apart from the tank bottom wall by a specified clearance, and wherein communicating portions that communicate between the front side and the rear side of the bottom paddle are formed at positions away from the lower end edge upward by a specified amount.

2. The agitator according to claim 1, wherein the communicating portions are formed along a radial direction of the agitation tank.

3. The agitator according to claim 1, wherein the communicating portions comprise at least one of holes and openings.

4. The agitator according to claim 1, wherein the connecting portions are formed in the bottom paddle respectively on the right and left sides thereof with the rotating shaft therebetween.

5. The agitator according to claim 4, wherein the communicating portions are formed to be symmetric on the right and left sides around the rotating shaft.

6. The agitator according to claim 1, wherein the agitating impeller further comprises a lattice blade located above the bottom paddle.

7. The agitator according to claim 6, wherein the lattice blade is arranged to have a width in the radial direction which gradually narrows towards the above.

8. An agitation method comprising: agitating an object within an agitation tank by the use of an agitator that includes a rotating shaft that is disposed outside of the tank along the axis of a vertically oriented cylindrical agitation tank to be rotatable, and
a flat agitation impeller made up of a bottom paddle, which lower end edge is formed to be of a shape that conforms with a tank bottom wall such that a specified clearance is formed between the lower end edge and the tank bottom wall, the bottom paddle being provided with communicating portions at positions away from the lower end edge upward by a specified amount for communicating between the front side and the rear side of the bottom paddle, and being mounted to the rotating shaft so as to locate close to the tank bottom wall and extend towards a sidewall of the tank.

9. The agitation method according to claim 8, wherein the object is agitated in a streamline flow region.
